(19) United States
(12) Patent Application Publication
(10) Pub. No.: US 2026/0226867 A1
(43) Pub. Date: Aug. 6, 2026

(54) MIXED-COMBUSTION ELECTRONIC CONTROL DEVICE

(71) Applicant: Hitachi, Ltd., Tokyo (JP)

(72) Inventor: Atsushi SHIMADA, Tokyo (JP)

(21) Appl. No.: 19/151,359

(22) PCT Filed: Mar. 29, 2024
(86) PCT No.: PCT/JP2024/013354

§ 371 Date: Jul. 28, 2025

(30) Foreign Application Priority Data
May 25, 2023 (JP) 2023-086167

(51) Int. Cl. F02D 19/06; F02D 19/08; F02D 41/00; F02P 5/15

(52) U.S. Cl. CPC F02D 19/0602; F02D 19/0626; F02D 19/081; F02D 41/0097; F02P 5/1502; F02D 2200/101

(57) ABSTRACT

This mixed-combustion electronic control device includes a first controller (11) that controls combustion of a first fuel and a second controller (12) that controls mixed combustion of the first fuel and a second fuel. The second controller (12) stores, for each engine operating condition, observation values (for example, the extreme value of the rotation speed of the crankshaft and the extreme value timing) corresponding to the combustion timing of the first fuel (S504). The second controller (12) learns the observation values corresponding to the combustion timing of the first fuel suitable for each operating condition (S503). The second controller (12) determines whether to perform mixed combustion from the current operating conditions and learning situation (S505). In a case where it is determined that mixed combustion is to be performed, the second controller (12) controls the mixed combustion by using the learned observation values (S506).

### TECHNICAL FIELD

The present invention relates to a mixed-combustion electronic control device.

### BACKGROUND ART

As a decarbonization system for reducing the use of fossil fuels, a mixed-combustion engine system utilizing fuels generated by renewable energy has been studied for power generation applications and cogeneration applications. Examples of renewable-energy derived fuel include hydrogen and ammonia. Hydrogen has a combustion speed that is about 7 times or more that of a conventional hydrocarbon fuel, and ammonia has a combustion speed that is ⅕ of that of a conventional hydrocarbon fuel. Thus, the combustion characteristics are greatly different.

Because hydrogen has a high combustion speed, abnormal combustion such as pre-ignition and backfiring is likely to occur. In addition, ammonia causes misfiring or a decrease in thermal efficiency due to slow combustion timing. In light of such a background, it is necessary to control the combustion timing and the like at the time of mixed combustion of the renewable energy-derived fuel and the conventional fuel.

In order to appropriately control the combustion timing according to the mixed-combustion rate of the fuel, the controller implementation map is enlarged and development costs increase. In addition, on-board detection of the combustion timing requires installation of a combustion pressure sensor, which is accompanied by hardware modifications for additional installation and an increase in cost.

As described above, it is necessary to detect the combustion state in real time in order to suppress abnormal combustion and misfiring in a mixed combustion engine that partially utilizes a hydrocarbon fuel and a fuel having different combustibility (hydrogen, ammonia, or the like). A technique for detecting a combustion state is disclosed in PTL 1.

PTL 1 describes means for detecting combustion timing without additional modification. Specifically, this method utilizes a rotation sensor of an engine crankshaft. This method uses the crank rotation sensor to estimate the combustion centroid from extreme value timing of the crank angular velocity. This method enables the combustion centroid to be estimated without additional sensors, but a correlation map for correlation with combustion timing acquired in advance under various conditions is required, thus necessitating a significant change in existing controller-implementation software.

### CITATION LIST

### Patent Literature

PTL 1: JP 2021-161904 A

### SUMMARY OF INVENTION

### Technical Problem

In order to establish a mixed-combustion engine system with renewable energy-derived fuel, it is necessary to perform on-board combustion detection and control without significant modification of the engine and without a significant change in the implementation software of the controller. To this end, it is necessary to be able to detect and control the combustion timing of mixed combustion without changing the software of an existing controller of a base fuel system and without an additional sensor.

The purpose of the present invention is to provide a mixed-combustion electronic control device capable of performing mixed combustion suitable for operating conditions of an engine and without map data acquired in advance, while suppressing a change to software of a first controller.

### Solution to Problem

In order to achieve the above object, a mixed-combustion electronic control device according to the present invention includes a first controller that controls combustion of a first fuel; and a second controller that controls mixed combustion of the first fuel and a second fuel, wherein the second controller stores, for each engine operating condition, observation values corresponding to combustion timing of the first fuel, learns observation values corresponding to the combustion timing of the first fuel suitable for each of the operating conditions, determines, from the current operating conditions and learning situation, whether to perform the mixed combustion, and, in a case where it is determined that the mixed combustion is to be performed, controls the mixed combustion by using the learned observation values.

### Advantageous Effects of Invention

According to the present invention, it is possible to perform mixed combustion suitable for the operating conditions of the engine without map data acquired in advance, while suppressing a change to software of the first controller. Problems, configurations, advantageous effects other than those described above will be clarified by the following descriptions of the embodiments.

### BRIEF DESCRIPTION OF DRAWINGS

FIG. 1 is a schematic diagram of an engine system for mixed combustion of renewable energy-derived fuel.

FIG. 2 is a configuration diagram of a mixed-combustion electronic control device.

FIG. 3 is a diagram illustrating an example of an electromagnetic pickup signal in a system using electromagnetic pickup.

FIG. 4 is a diagram illustrating an example of a rotation time profile.

FIG. 5 is a diagram illustrating a control flow of the mixed-combustion electronic control device.

FIG. 6 is a relationship diagram between extreme value timing and the combustion centroid for each type of fuel.

FIG. 7 is a relationship diagram for ignition timing and the combustion centroid with respect to a hydrogen mixed-combustion rate.

FIG. 8 is a relationship diagram between the excess air ratio for each fuel and angular-velocity extreme value timing at the time of MBT.

FIG. 9 is a diagram for determining normal combustion and abnormal combustion from extreme value timing and an extreme value.

### DESCRIPTION OF EMBODIMENTS

Hereinafter, examples of modes for carrying out the present invention will be described with reference to the accompanying drawings. In the present specification and the accompanying drawings, constituent elements having substantially the same function or configuration are denoted by the same reference signs, and thus redundant descriptions thereof are omitted.

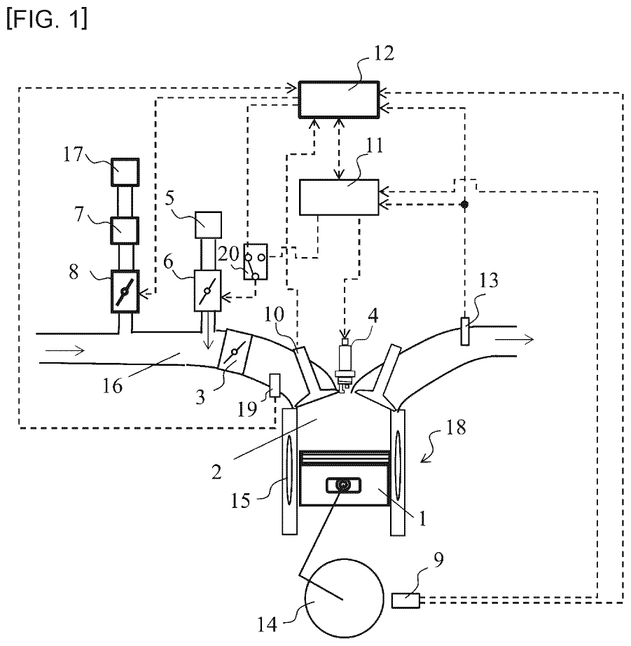

FIG. 1 is a schematic diagram of an engine system 18 that uses a first fuel (existing fuel) and a second fuel (renewable energy-derived fuel). Note that, in FIG. 1, only main control lines (broken lines) are illustrated for easy viewing of the drawing.

In the engine system 18, the first fuel (for example, hydrocarbon fuel) is supplied to an intake port 16 by controlling a first fuel flow-rate adjustment device 6. The second fuel (for example, hydrogen, ammonia, biogas, carburizing furnace flue gas, off-gas, and the like) is supplied to the intake port 16 by controlling a second fuel flow-rate adjustment device 8. The first fuel, the second fuel, and air are mixed in the intake port 16 and supplied to a combustion chamber 2. The amount of gas supplied to the combustion chamber 2 is adjusted by adjusting the degree of opening of a throttle valve 3 built into the intake port 16. The degree of opening of the throttle valve 3 is detected by an opening degree sensor (not illustrated) and is output to a first controller 11.

The mixed gas supplied to the combustion chamber 2 is compressed by a piston 1 to have a high temperature and a high pressure, and in this state, ignition is performed at a predetermined timing by the spark plug, and combustion is started. In a case where the proportion of hydrogen or the like having a high combustion speed is large, the ignition timing is delayed, and in a case where the proportion of ammonia or an inert gas mixed gas having a low combustion speed is large, the ignition timing is advanced, and thus combustion with high thermal efficiency can be performed.

An air-fuel mixture of fuel and air is ignited by ignition of a spark plug 4, a combustion pressure increases due to flame propagation, and torque is generated in the piston 1. The vertical movement of the piston 1 is converted into the rotational movement of a crankshaft 14. A generator (not illustrated) is connected to the crankshaft 14, and the generator generates power as the crankshaft 14 rotates.

The second fuel is, for example, a gas partially using hydrogen as a fuel, and is a hydrogen-rich gas, a natural gas partially containing hydrogen, a biogas partially containing hydrogen, a synthetic gas partially containing hydrogen, ammonia, a reformed gas, or the like. The reformed gas is, for example, a gas obtained by reforming natural gas, biogas, a biofuel such as ethanol, ammonia, or a synthetic fuel. These gases are supplied from a second fuel storage device 7. The gas generated by a hydrogen generation device 17 is stored in the second fuel storage device 7. Without providing the second fuel storage device 7, the chemical plant or the water decomposition device may be directly connected to the second fuel flow-rate adjustment device 8 (the hydrogen generation device 17 may be directly connected).

As the hydrogen generation device 17, for example, an electrolysis device that breaks down water into hydrogen and oxygen or a reformer into which a catalyst is inserted, or the like, is used. In a case where the hydrogen generation device 17 is an electrolysis device, electricity generated from renewable energy such as solar power generation or wind power generation is utilized as the electricity to be supplied. In a case where the hydrogen generation device 17 is a reformer, hydrocarbon fuel or ammonia is supplied to the reformer and reformed to generate hydrogen. Any one or more of an engine exhaust, cooling water (cooling water 15 or cooling water supplied from the outside), and an electric heater are supplied to the reformer, and the reformer is controlled to a predetermined temperature.

When the remaining amount of the second fuel storage device 7 decreases, the hydrogen-containing gas generated by the hydrogen generation device 17 is stored. The gas containing a higher hydrogen content is extracted according to the remaining amount of the second fuel storage device. In the case of using a hydrogen-occlusion alloy, an organic hydride, or ammonia, either one or both of an engine exhaust and cooling water is/are supplied, and a hydrogen-containing gas is extracted.

The first controller 11 controls the ignition timing on the basis of signals from a crank angle sensor 9 and a cam sensor 10 that detect the rotation timing of the engine. The injection timing of the first fuel is controlled on the basis of the rotation speed of the engine, the estimated torque (estimated from the intake pressure, an air flow meter, or the like), and a signal from an O2 sensor in the exhaust. The second fuel partially contains hydrogen, and therefore combustion of the premixed gas of the second fuel and air is established even under a ratio of excess air rather than the stoichiometric ratio, that is, a high excess air ratio condition. Therefore, when the second fuel is additionally supplied to the intake air of the conventional engine for spark ignition combustion, mixed combustion is established even under a wide excess air ratio condition. In the present embodiment, a signal from the cam sensor 10 is input to the first controller 11 via a second controller 12, but may be input directly to the first controller 11.

The second controller 12 is a device that controls a mixing ratio, a fuel amount, and an ignition timing of a plurality of fuels that are mixed and combusted in a combustion chamber (combustion chamber 2) of a mixed combustion engine (engine system 18) including the first fuel flow-rate adjustment device 6 and the second fuel flow-rate adjustment device 8 described above. The second controller 12 is connected to the first fuel flow-rate adjustment device 6 and the second fuel flow-rate adjustment device 8, and can adjust the amount of each fuel to be supplied to the engine. The first fuel flow-rate adjustment device 6 can also be controlled by the first controller 11, and a controller connected to the first fuel flow-rate adjustment device 6 can be selected by the controller switching device 20 (the first controller 11 or the second controller 12 can be switched).

The second controller 12 detects the combustion timing of the engine on the basis of detection results (signals) of the crank angle sensor 9 and the cam sensor 10. The ignition timing is controlled by the first controller 11 (engine control controller), but a signal (sensor value) from the cam sensor, which constitutes reference timing for controlling the ignition timing, is input to the first controller 11 after being controlled by the second controller 12. Accordingly, the first fuel flow-rate adjustment device 6, the second fuel flow-rate adjustment device 8, and the ignition timing can be controlled by the second controller 12 on the basis of the detected combustion timing of the engine.

The throttle valve 3 adjusts the degree of opening so that the rotation speed of the engine falls within a predetermined range. An intake pressure sensor 19 or an air flow meter is connected to an intake pipe, and a signal is supplied to the second controller 12. As a result, the second controller 12 can control the first fuel flow-rate adjustment device 6, the second fuel flow-rate adjustment device 8, and the ignition timing according to the amount of air.

An O2 sensor 13 for ascertaining the oxygen concentration in the exhaust gas is attached to the exhaust pipe, and the O2 sensor 13 is connected to the second controller 12. The air-fuel ratio or the excess air ratio can be detected in real time by the second controller 12, and the first fuel flow-rate adjustment device 6, the second fuel flow-rate adjustment device 8, and the ignition timing can be controlled according to the value of the air-fuel ratio or the excess air ratio.

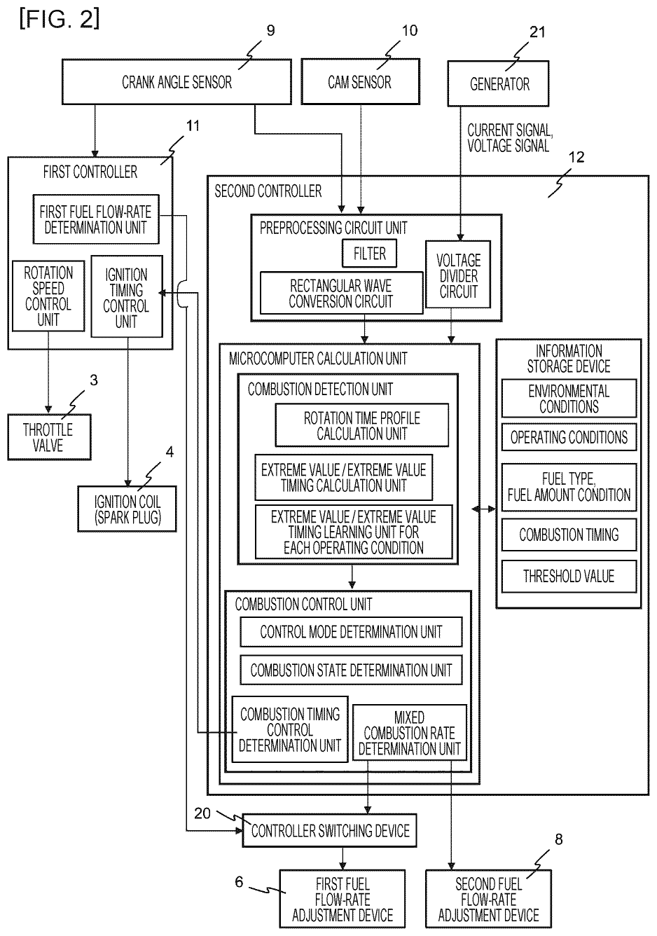

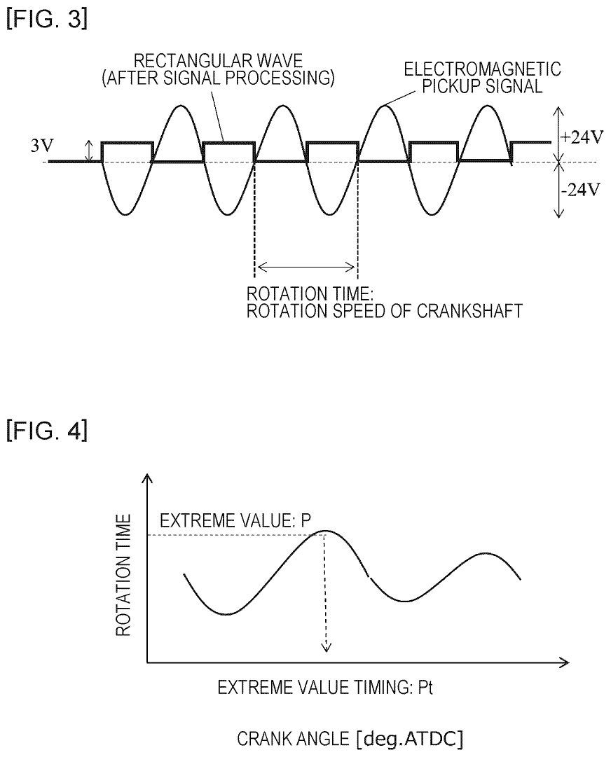

FIG. 2 is a configuration diagram of the second controller 12. The crank angle sensor 9 and the cam sensor 10 are input to the second controller 12. At least one or more of the signals (sensor values) from a current sensor or a voltage sensor of a generator 21 is input to the second controller 12. The crank angle sensor 9 and the cam sensor 10 are subject to shaping by a preprocessing circuit and then supplied to a microcomputer (microcomputer calculation unit). In a case where the crank angle sensor 9 and the cam sensor 10 are electromagnetic pickups, because signals are supplied at a voltage of ±24V H more as shown in FIG. 3, the crank angle sensor 9 and the cam sensor 10 cannot be directly supplied to the microcomputer. Therefore, the signals are converted into a 3V rectangular wave before being input to the microcomputer. Further, the current and voltage signals of the generator 21 are set to 3V or less by the voltage divider circuit and then input to a microcomputer.

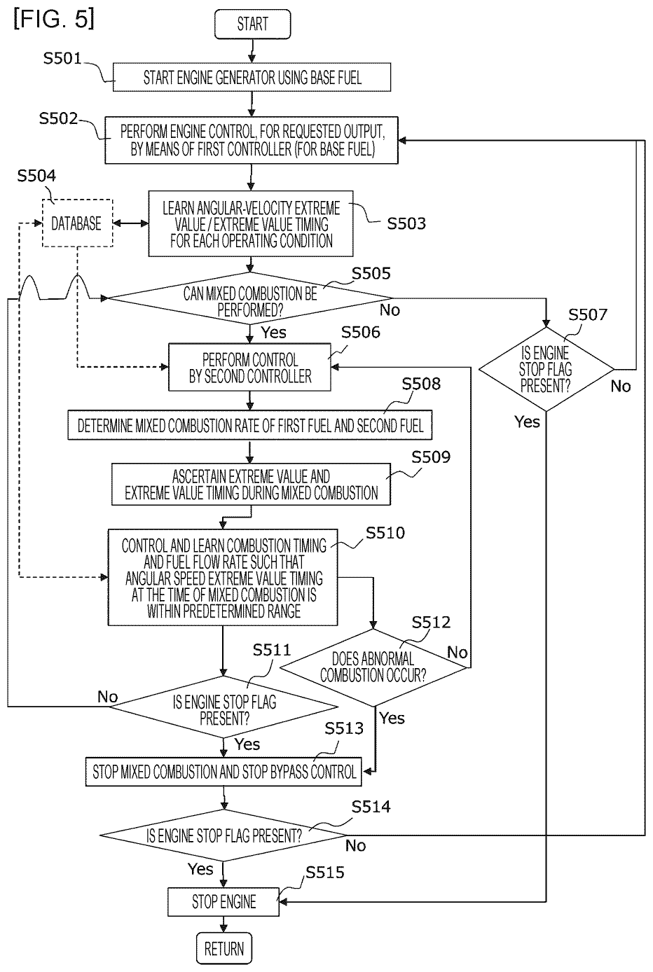

The combustion detection unit calculates a rotation time profile by using a signal input to the microcomputer. As illustrated in FIG. 3, the time between the falling edge of the rectangular wave converted from the signal of the crank angle sensor 9 is acquired, and the rotation time profile can be acquired by taking an average value for each cycle. The rotation time profile in FIG. 4 is obtained (calculated) by means of Fourier series expansion of the rotation time profile.

Next, the extreme value and extreme value timing calculation unit acquires the extreme value: P and the extreme value timing: Pt of the rotation time profile. In the case of a one-cylinder engine, an extreme value: P and an extreme value timing Pt can be acquired per an engine cycle (one for two revolutions of the crank), and in the case of an N-cylinder engine, N extreme values P and N extreme value timings Pt can be acquired. That is, the extreme value P(n) and the extreme value timing Pt(n) for each cylinder can be acquired (n=1, 2, . . . , N). The extreme value and the extreme value timing are learned for each of the operating conditions (conditions defined by the generated power, the excess air ratio, the engine speed, torque, and the like). Thereafter, a signal is passed from the combustion detection unit to the combustion control unit. The combustion control unit is classified into functions of a control mode determination unit (fuel mode determination unit), a combustion state determination unit, a combustion timing control determination unit, and a mixed combustion rate determination unit.

The control mode determination unit determines whether control is to be performed by the first controller 11 (for base fuel) or by the second controller 12. Control is performed by the first controller 11 upon starting, and when the learning data can be acquired after a predetermined time elapses and under the operating conditions, the processing advances to the control by the second controller 12.

The combustion state determination unit determines, from the extreme value and the extreme value timing, whether combustion is being performed at a highly efficient timing. The combustion timing control determination unit controls the ignition timing on the basis of the determination result. The mixed combustion rate determination unit determines the mixed combustion ratio.

FIG. 5 is a flowchart of control using the mixed-combustion electronic control device. In S501, the engine is started using the base fuel (for example, hydrocarbon fuel). In step S502, the first controller 11 controls the requested power generation output. The results (an extreme value and an extreme value timing) calculated by the extreme value/extreme value timing calculation unit are stored in the database in association with the operating conditions in S504. Then, in S503, the extreme value and the extreme value timing for each operating condition are learned. The control mode determination unit determines, from the learning situation, whether mixed combustion can be performed (S505).

When the mixed combustion is enabled in S505, the processing advances to the control by the second controller 12 in S506. If it is determined in S505 that mixed combustion cannot be performed, the processing advances to the presence or absence of an engine stop flag. If there is no stop flag, the processing returns to S502, data is acquired under various conditions using the base fuel, and learning is performed Note that the case where mixed combustion cannot be performed in S505 is either a case where data for performing mixed combustion is insufficient or a case where the engine has not reached a predetermined operating state due to a warm-up condition or the like.

In a case where the control by the second controller 12 can be performed, the mixed combustion rate determination unit determines the flow rate ratios of the first fuel and the second fuel in S508, and sends a signal (control command) to the first fuel flow-rate adjustment device 6 and the second fuel flow-rate adjustment device 8 to control the flow rate of each fuel.

The extreme value and the extreme value timing at the time of mixed combustion are ascertained in S509, the combustion timing, the first fuel flow rate, and the second fuel flow rate are controlled so that the extreme value and the extreme value timing at the time of mixed combustion are within a predetermined range in S510, and the information is learned and stored in the database in S504. In a case where abnormal combustion occurs in S512, the mixed combustion is stopped and the bypass control (control by the second controller 12) is stopped, and if an engine stop flag is present, the engine is stopped. In a case where there is no engine stop flag, the first controller 11 (engine control controller) performs engine control using the base fuel.

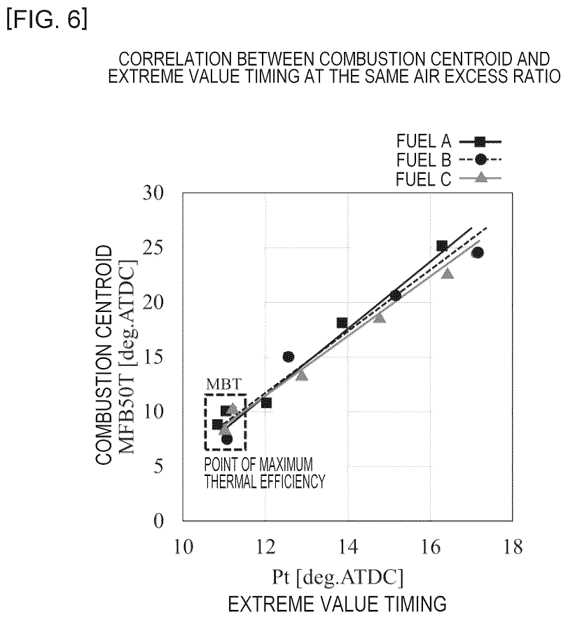

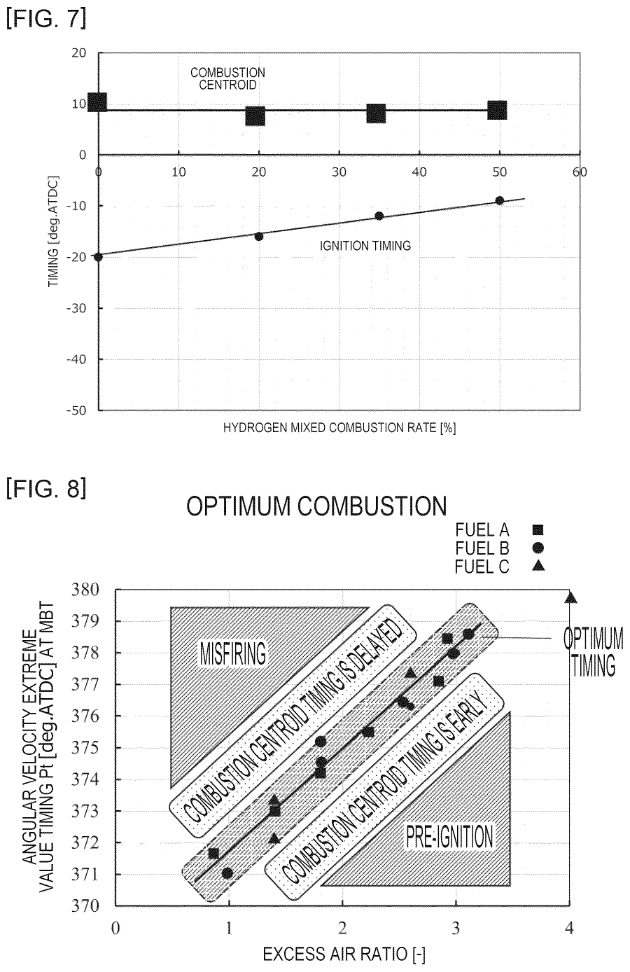

FIG. 6 illustrates the relationship between the extreme value timing Pt and the combustion centroid (mass fraction burned timing (MFB50T)) of the fuel, which are different under the same operating conditions (the same output, same rotation speed, same air excess ratio (air-fuel ratio)). By setting the extreme value timing within a predetermined range (in the example of FIG. 6, Pt: 10.5 to 11.5), an optimum ignition condition (minimum advanced for best torque (MBT)) is obtained. This is because the optimum (maximum efficiency) combustion centroid for each operating condition does not depend on the combustion type. FIG. 7 shows the relationship between the hydrogen mixed combustion rate, the ignition timing, and the combustion centroid when methane is used as the first fuel and hydrogen is used as the second fuel. As the hydrogen mixed combustion rate increases, the ignition timing is retarded, but the combustion centroid (MFB50T) becomes constant. In addition, because the combustion centroid (MFB50T) and the extreme value timing Pt have a linear relationship, if the operation is performed at the extreme value timing Pt within a predetermined range under the same operating conditions, the operation can be performed at the maximum thermal efficiency without depending on the combustion type.

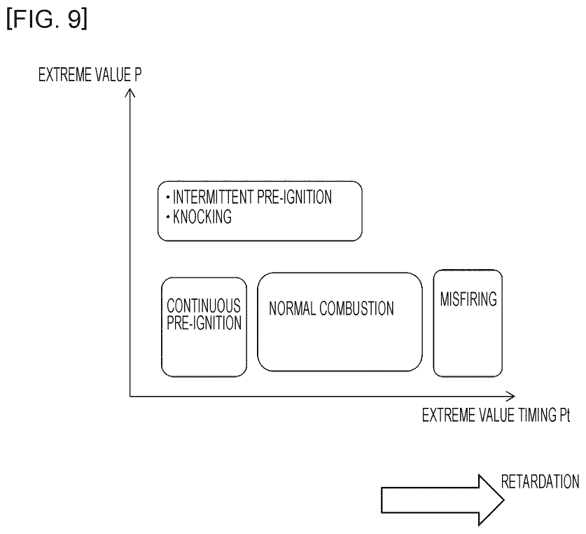

Next, the dependency of the Pt timing (hereinafter the optimum Pt timing) on the air excess ratio under the MBT condition will be described. FIG. 8 illustrates changes in the optimum Pt timing when the excess air ratio is different under the condition of the same engine speed and output. It can be seen that the optimum Pt timing changes due to the difference in the excess air ratio, and this change depends on the large change in the history of the in-cylinder pressure due to a change in the working gas supplied to the engine when the excess air ratio λ changes. That is, the optimum Pt timing is determined for each engine speed, output, and excess air ratio, and does not depend on the fuel type.

In the case of implementation based on the above basic idea, the optimum Pt timing is different in a case where the size and type of the engine and the type of rotation sensor (crank angle sensor) are different. Therefore, it is important to first ascertain the extreme value timing Pt of the base control in a wide operating range using the base fuel. Because the base control is controlled at the combustion timing of the maximum thermal efficiency or the low exhaust, the ignition timing and the combustion type can be controlled on the basis of the optimum extreme value timing Pt at the time of mixed combustion by using base fuel to learn the optimum extreme value timing Pt.

In the event of a deviation from the normal combustion area shown in FIG. 8, the combustion centroid is delayed on the retardation angle side, and misfiring takes place when a large deviation curs. On the other hand, on the advance angle side, the combustion centroid is then early, and in the event of a large deviation, pre-ignition occurs. That is, the state of combustion can be determined by looking at the angle of deviation from the optimum combustion area. Accordingly, a control value of the ignition timing for optimum combustion is determined.

FIG. 9 illustrates areas of each of the types of normal combustion and abnormal combustion with respect to the extreme value timing and the extreme value. When the extreme value timing is retarded, a misfiring abnormality occurs, and when the extreme value timing is advanced, continuous pre-ignition (abnormal combustion) occurs. Even when the extreme value timing is normal, intermittent pre-ignition or knocking may occur. Because intermittent pre-ignition and knocking cannot be determined by considering only the extreme value timing, it is necessary to ascertain the extreme value. In light of the foregoing, it is possible to determine normal combustion or abnormal combustion (including the type) by looking at both the extreme value and the extreme value timing.

The main features of the present embodiment can also be rephrased as follows.

The mixed-combustion electronic control device includes a first controller 11 that controls combustion of a first fuel (for example, hydrocarbon fuel) and a second controller 12 that controls mixed combustion of the first fuel and a second fuel (for example, hydrogen) (FIG. 1). The second controller 12 stores, for each engine operating condition, observation values (for example, the extreme value of the rotation speed of the crankshaft and the extreme value timing) corresponding to the combustion timing of the first fuel (S504, FIG. 5). The second controller 12 learns the observation value corresponding to the combustion timing of the first fuel suitable for each operating condition (S503). The second controller 12 determines whether to perform mixed combustion in light of the current operating conditions (the generated power, the excess air ratio, the engine speed, the torque, and the like) and the learning situation (for example, whether the amount of learning data is sufficient) (S505). In a case where it is determined that mixed combustion is to be performed, the second controller 12 controls the mixed combustion by using the learned observation value (S506).

The first controller 11 controls the combustion of the first fuel and the second controller 12 controls the mixed combustion, and thus mixed combustion can be performed while suppressing a change to software of the first controller 11 (such as a map change).

In addition, because the observation value corresponding to the combustion timing of the first fuel suitable for the operating condition does not depend on the combustion type, it is possible, by using the learned observation value, to perform mixed combustion suitable for the operating condition without using the map.

For example, in a case where the amount of learning data is insufficient or in a case where the current operating conditions are the operating conditions of the warm-up operation (for example, generated power: low, excess air ratio: low, engine speed: low, torque: low), the second controller 12 determines that the mixed combustion is not to be performed. On the other hand, for example, in a case where the amount of learning data is sufficient and the current operating conditions are the operating conditions at the time of power generation, the second controller 12 determines that mixed combustion is to be performed. Learning of observation values (machine learning) is performed using, for example, a neural network model.

In the present embodiment, as illustrated in FIG. 4, the observation value is the extreme value P of the rotation speed of the crankshaft and the extreme value timing Pt indicating the timing at which the rotation speed is at the extreme value P. The second controller 12 detects the extreme value P and the extreme value timing Pt. The second controller 12 stores the extreme value P and the extreme value timing Pt for each operating condition. £ The second controller 12 learns the extreme value P and the extreme value timing Pt suitable for each operating condition.

For example, by using the signals of the existing crank angle sensor 9 and the cam sensor 10 with which the engine is provided, it is possible to learn the extreme value P and the extreme value timing Pt of the rotation speed of the crankshaft corresponding to the combustion timing of the first fuel suitable for each operating condition without newly adding an in-cylinder pressure sensor or the like.

In a case where it is determined that mixed combustion is to be performed, the second controller 12 (the combustion timing control determination unit, FIG. 2) determines the ignition timing SO that the extreme value timing Pt corresponding to the combustion timing of the mixed combustion under the current operating conditions approaches the extreme value timing corresponding to the combustion timing of the first fuel suitable for the operating conditions (S510, FIG. 5).

As a result, the combustion timing of the mixed combustion under the current operating conditions can be brought close to the combustion centroid. As a result, the thermal efficiency of the mixed combustion is improved.

Specifically, in a case where the extreme value timing Pt of the current operating conditions is later than the extreme value timing suitable for the operating conditions, the second controller 12 outputs a control signal including a command to advance the ignition timing to the first controller 11. On the other hand, in a case where the extreme value timing Pt of the current operating conditions is earlier than the extreme value timing suitable for the operating conditions, the second controller 12 outputs a control signal including a command to retard the ignition timing to the first controller 11. The first controller 11 controls the ignition timing according to the command included in the control signal.

By retarding or retarding the ignition timing, the combustion timing of mixed combustion under the current operating conditions can be brought close to the combustion centroid.

In a case where a determination is made to perform mixed combustion, the second controller 12 (the mixed combustion rate determination unit, FIG. 2) determines the mixed combustion rate (the fuel flow rate ratio) so that the extreme value timing corresponding to the combustion timing of mixed combustion under the current operating conditions approaches the extreme value timing corresponding to the combustion timing of the first fuel suitable for the operating conditions (S510, FIG. 5).

As a result, the combustion timing of the mixed combustion under the current operating conditions can be brought close to the combustion centroid. As a result, the thermal efficiency of the mixed combustion is improved.

Specifically, the combustion speed of the second fuel (for example, hydrogen) is greater than the combustion speed of the first fuel (for example, hydrocarbon fuel), for example. In a case where the extreme value timing Pt of the current operating conditions is later than the extreme value timing suitable for the operating conditions, the second controller 12 increases the mixed combustion rate of the second fuel (for example, hydrogen). On the other hand, when the extreme value timing Pt of the current operating conditions is earlier than the extreme value timing suitable for the operating conditions, the second controller 12 decreases the mixed combustion rate of the second fuel (for example, hydrogen).

By adjusting the mixed combustion rate, the combustion timing of mixed combustion under the current operating conditions can be brought close to the combustion centroid. The initial value of the mixed combustion rate is stored in, for example, a storage device such as a nonvolatile memory, but may be calculated from environmental conditions such as air temperature and cooling water temperature.

In a case where it is determined that mixed combustion is to be performed, the second controller 12 compares the extreme value timing Pt corresponding to the combustion timing of the mixed combustion under the current operating conditions with the extreme value timing corresponding to the combustion timing of the first fuel suitable for the operating conditions, and determines the combustion state of the mixed combustion (FIG. 8).

As a result, the combustion state of mixed combustion (misfiring, normal combustion, pre-ignition) can be determined from the extreme value timing Pt.

The second controller 12 compares the extreme value P and the extreme value timing Pt corresponding to the combustion timing of mixed combustion under the current operating conditions with the extreme value and the extreme value timing corresponding to the combustion timing of the first fuel suitable for the operating conditions, and determines the combustion state of mixed combustion (FIG. 9).

As a result, the combustion state of mixed combustion (intermittent pre-ignition and knocking in addition to misfiring, normal combustion, and continuous pre-ignition) can be determined from the extreme value P and the extreme value timing Pt.

As shown in FIG. 2, the mixed-combustion electronic control device includes a switching device (the controller switching device 20) that switches between a first control signal from the first controller 11 to the first fuel flow-rate adjustment device 6 for adjusting the flow rate of the first fuel, and a second control signal from the second controller 12 to the first fuel flow-rate adjustment device 6. In a case where the mixed combustion rate is to be changed, the second controller 12 controls the switching device (the controller switching device 20) to switch from the first control signal to the second control signal.

Thus, the mixed combustion rate can be changed without changing the control (software) of the first controller 11.

The engine drives the generator 21. The operating conditions include, for example, one or more of the generated power, the generated current, the excess air ratio, the engine speed, and the torque.

Because the second controller 12 improves or optimizes the thermal efficiency of the mixed combustion in accordance with the operating conditions of the engine, the fuel efficiency of the generator 21 is improved.

Note that the present invention is not limited to the above-described embodiment and includes various modifications. For example, the above-described embodiments have been described in detail for easy understanding of the present invention, but the present invention is not necessarily limited to embodiments having all the described configurations. Further, part of the configuration of one embodiment can be replaced with the configuration of another embodiment, and the configuration of another embodiment can also be added to the configuration of the one embodiment. In addition, it is possible to add or delete other configurations to/from part of the configuration of each embodiment, or other configurations can be substituted for part of the configuration of each embodiment.

Gasoline may be used as the first fuel, and a fuel injection device (injector) may be used as the first fuel flow-rate adjustment device 6.

In addition, some or all of the above-described configurations, functions, and the like may be realized by hardware, for example, by a design using an integrated circuit. Furthermore, each of the above-described configurations, functions, and the like may be implemented by software as a result of the processor (microcomputer) parsing and executing programs that implement the respective functions. Information such as programs, tables, and files for realizing each function can be stored in a recording device such as a memory, a hard disk, or a solid state drive (SSD), or on a recording medium such as an IC card, an SD card, or a DVD.

Note that the embodiments of the present invention may have the following modes.
(1). A mixed-combustion electronic control device in an engine that generates power by using a first fuel (base fuel) and a second fuel, the electronic control device having a second controller separately from the first controller (for base fuel), wherein the second controller has at least one function among a function for detecting a combustion state of the engine, a function for storing a combustion state under various conditions during base fuel operation, a fuel mode determination function for determining whether to perform mixed combustion on the basis of the stored information, a combustion state determination function for determining a combustion state, a combustion timing control determination function for controlling a combustion timing, and a mixed-combustion rate determination function for determining a mixed-combustion rate.
(2). The mixed-combustion electronic control device according to (1), the device having a calculation function for calculating an extreme value and an extreme value timing in a cycle of a rotation speed of a crankshaft on the basis of signals of a crank rotation sensor and a cam sensor of the engine which are input to the second controller by the rotation sensor and the cam sensor, and the device having a learning function for learning the calculated extreme value and an extreme value timing for each operating condition, and having a control mode determination function for determining, on the basis of the calculation function and the learning function, whether to perform a mixed combustion mode.
(3). The mixed-combustion electronic control device according to either (1) or (2), wherein a timing control signal is output to the first controller on the basis of a result determined by the combustion timing control determination unit, and wherein the first controller includes an ignition timing control unit that controls an ignition timing on the basis of the timing control signal.
(4). The mixed-combustion electronic control device according to either (1) or (2), further including a controller switching device 20 capable of switching, between a first controller and a second controller, a controller for controlling the first fuel flow-rate adjustment device on the basis of the result determined by the combustion timing control determination unit.

According to (1) to (4), the combustion timing at the time of mixed combustion can be controlled in real time without adding an in-cylinder pressure sensor or the like and without significantly modifying the software of the existing controller. Due to this configuration, the second fuel can be subjected to mixed combustion without significantly modifying existing controllers, for a wide variety of engine systems. Because various types of engines can be used using this method, it is possible to use renewable energy-derived fuel and circular economy-derived fuel in any engine such as an automobile engine, an industrial engine, or a marine engine. Further, because this method can also be applied to used or discarded engines, this method can also contribute to recycling.

### REFERENCE SIGNS LIST

1 piston
2 combustion chamber
3 throttle valve
4 spark plug
5 first fuel (base fuel) storage device
6 first fuel flow-rate adjustment device
7 second fuel storage device
8 second fuel flow-rate adjustment device
9 crank angle sensor
10 cam sensor
11 first controller
12 second controller
13 O2 sensor
14 crank shaft
15 cooling water
16 intake port
17 hydrogen generation device
18 engine system
19 intake pressure sensor
20 controller switching device
21 generator

1. A mixed-combustion electronic control device, comprising:
a first controller that controls combustion of a first fuel; and
a second controller that controls mixed combustion of the first fuel and a second fuel,
wherein the second controller
stores, for each engine operating condition, observation values corresponding to combustion timing of the first fuel,
learns observation values corresponding to the combustion timing of the first fuel suitable for each of the operating conditions,
determines, from the current operating conditions and learning situation, whether to perform the mixed combustion, and
in a case where it is determined that the mixed combustion is to be performed, controls the mixed combustion by using the learned observation values.

2. The mixed-combustion electronic control device according to claim 1,
wherein the observation values are an extreme value of a rotation speed of a crankshaft and an extreme value timing indicating the timing at which the rotation speed is at the extreme value, and
wherein the second controller
detects the extreme value and the extreme value timing,
stores the extreme value and the extreme value timing for each of the operating conditions, and
learns the extreme value and the extreme value timing suitable for each of the operating conditions.

3. The mixed-combustion electronic control device according to claim 2, wherein, in a case where it is determined that mixed combustion is to be performed, the second controller determines the ignition timing so that the extreme value timing corresponding to the combustion timing of the mixed combustion under the current operating conditions approaches the extreme value timing corresponding to the combustion timing of the first fuel suitable for the operating conditions.

4. The mixed-combustion electronic control device according to claim 3,
wherein the second controller
outputs, to a first controller, a control signal including a command to advance ignition timing in a case where the extreme value timing of the current operating conditions is later than the extreme value timing suitable for the operating conditions, and
outputs, to the first controller, a control signal including a command to retard the ignition timing in a case where the extreme value timing of the current operating conditions is earlier than the extreme value timing suitable for the operating conditions, and
wherein the first controller controls the ignition timing according to the command included in the control signal.

5. The mixed-combustion electronic control device according to claim 2, wherein, in a case where it is determined that mixed combustion is to be performed, the second controller determines the mixed combustion rate so that the extreme value timing corresponding to the combustion timing of the mixed combustion under the current operating conditions approaches the extreme value timing corresponding to the combustion timing of the first fuel suitable for the operating conditions.

6. The mixed-combustion electronic control device according to claim 5,
wherein the combustion speed of the second fuel is greater than the combustion speed of the first fuel, and
wherein the second controller
increases the mixed combustion rate of the second fuel in a case where the extreme value timing of the current operating conditions is later than the extreme value timing suitable for the operating conditions, and
reduces the mixed combustion rate of the second fuel in a case where the extreme value timing of the current operating conditions is earlier than the extreme value timing suitable for the operating conditions.

7. The mixed-combustion electronic control device according to claim 2, wherein, in a case where it is determined that mixed combustion is to be performed, the second controller compares the extreme value timing corresponding to the combustion timing of the mixed combustion under the current operating conditions with the extreme value timing corresponding to the combustion timing of the first fuel suitable for the operating conditions, and determines the combustion state of the mixed combustion.

8. The mixed-combustion electronic control device according to claim 2, wherein the second controller compares the extreme value and the extreme value timing that correspond to the combustion timing of the mixed combustion under the current operating conditions with the extreme value and the extreme value timing that correspond to the combustion timing of the first fuel suitable for the operating conditions, and determines the combustion state of the mixed combustion.

9. The mixed-combustion electronic control device according to claim 6, further comprising a switching device that switches between a first control signal from the first controller to the first fuel flow-rate adjustment device for adjusting the flow rate of the first fuel, and a second control signal from the second controller to the first fuel flow-rate adjustment device,
wherein, in a case where the mixed combustion rate is to be changed, the second controller controls the switching device to switch from the first control signal to the second control signal.

10. The mixed-combustion electronic control device according to claim 1,
wherein the engine drives a generator, and
wherein the operating conditions include one or more of generated power, generated current, excess air ratio, engine speed, and torque.
